(19) United States
(12) Patent Application Publication
(10) Pub. No.: US 2007/0029878 A1
(43) Pub. Date: Feb. 8, 2007

(54) Land clearing vehicle and track assembly therefor

(75) Inventors: Daniel Gaudreault, Summerville, SC (US); Guy Gaudreault, Forestville (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(73) Assignee: Gyro-Trac Inc.

(21) Appl. No.: 11/499,698

(22) Filed: Aug. 7, 2006

Related U.S. Application Data
(60) Provisional application No. 60/706,015, filed on Aug. 8, 2005.

(30) Foreign Application Priority Data
Aug. 8, 2005 (CA) 2,515,046

(51) Int. Cl. B62D 55/14

(52) U.S. Cl. 305/130

(57) ABSTRACT

A land clearing vehicle comprises a land clearing tool to be mounted thereon and to be activated thereby, and a track assembly for addressing and maneuvering through precarious terrain conditions. The land clearing tool is comprised of a generally vertical comb-like structure terminating in a set of substantially forward pointing teeth at the bottom thereof, and integrally coupling at the top thereof to a set of pivoting arms pivotally mounted on, and activated by, the vehicle. The tool can efficiently extract a tree stump from the ground and can be mounted on, and coupled with, other land clearing tools to provide efficient and productive land clearing options to the vehicle operator. The track assembly provides a protective casing for protecting the vehicle's track driving system, a set of roller guards for protecting the assembly's bottom rollers, and a tensioner assembly for providing a substantially constant tension in the track, thus protecting it and other track assembly components from unnecessary damage. The elevated driving sprocket wheel of the track assembly insures that the weight of the vehicle is distributed over the bottom rollers and not on the sprocket wheel, thereby significantly increasing the lifespan of the sprocket wheel.

### FIELD OF THE INVENTION

The present invention relates to land clearing vehicles. More specifically, this invention relates to a tool to be mounted on a land clearing vehicle for extracting tree stumps from the ground, and a track assembly therefor.

### BACKGROUND OF THE INVENTION

A wide variety of land clearing vehicles, and clearance tools to be used therewith, have been developed to execute a variety of tasks relating to agricultural, municipal and forestry work. Ultimately, the vehicles in question are designed to work and navigate through rough terrains in order to fulfill their tasks. Consequently, a wide variety of these vehicles are fitted with track systems to improve their maneuverability in such conditions. Though tracked vehicles are not uncommon in the art, certain weaknesses become apparent when these vehicles are put to work in rough conditions, such as, for example, in forestry work where the terrain generally comprises of steep and slippery slopes, rough unlevelled surfaces, and a variety of obstructions and interfering objects scattered throughout the work area. Necessarily, a rugged and highly optimised track system is required to manoeuvre in such conditions if one wishes to protect and extend the lifespan of the track assembly components, while providing for full operability.

Namely, conventional tracked vehicles, generally comprising tracks guided by sets of rollers and driven by drivable sprocket wheels of some type, can often fall victim to malfunctions in rough terrain conditions. For example, branches or debris can become jammed in the track assembly, either between the rollers, or around the sprocket wheel, which can in turn seriously damage the track and its components. Furthermore, insufficient protection of the track driving means, whether hydraulic or mechanical, often leads to damages induced by terrain obstacles and debris striking and obstructing the elements in question.

Another deficiency observed in conventional vehicles is the short lifespan of the track-driving sprocket wheels. For instance, the sprocket wheels of existing vehicles of this type are generally installed such that a significant fraction of the vehicle's weight is supported by the sprocket wheels, drastically reducing their lifespan as they must not only bear the weight and tension of the track, but also bear a significant portion of the vehicle's weight as well.

Finally, and more specifically related to forestry and agricultural tools to be mounted on the above vehicles, it is generally cumbersome to approach the task of removing an obstructing tree stump when clearing a particular work area. For instance, various clearing tools have been developed to take down trees and clear gathered debris, either removing it or mulching it with heavy-duty mulchers, but it is generally awkward to approach the task of removing leftover stumps with conventional equipment. A simple and efficient tree stump removal tool that can be mounted on a vehicle, or combined with other mounted tools, could efficiently tackle all elements of land clearing and significantly increase productivity and efficiency.

### SUMMARY OF THE INVENTION

In order to address the above and other drawbacks, and in accordance with the present invention, there is disclosed a track assembly for a tracked vehicle, the track assembly comprising an elongated trackframe comprising an inner panel and an outer panel, a set of bottom rollers rotatably mounted between a bottom inner edge of the inner panel and a bottom outer edge of the outer panel, and at least one roller guard mounted on the trackframe, the roller guard extending substantially downwardly from the trackframe to at least partially protect the rollers.

There is also disclosed a track assembly for a tracked vehicle, the track assembly comprising an elongated trackframe and a hollow protective casing at a first end thereof, a track, a track driving means comprising a motor, a drive train and a drivable sprocket wheel drivingly coupled thereto for driving the track, wherein the motor and the drive train are mounted in, and protected by, the protective casing.

Additionally, there is also disclosed a track assembly for a tracked vehicle, the track assembly comprising a trackframe and a set of rollers rotatably attached thereto, an automatic tensioner assembly comprising a restoring arm retractably coupled to the trackframe and extending outwardly therefrom to a tensioner wheel rotatably fastened thereto at a distal end thereof, and a track comprising an inner track surface moveably mounted on the tensioner wheel and the rollers.

Furthermore, there is disclosed a track assembly for a tracked vehicle, the track assembly comprising a substantially horizontal elongated trackframe and a set of rollers rotatably fastened thereto, a track comprising an inner track surface, a track driving means comprising a drivable sprocket wheel for driving the track, the sprocket wheel being rotatably mounted at a first distal end of the trackframe. The track inner surface is moveably mounted on the rollers and drivingly coupled to the sprocket wheel. The sprocket wheel is mounted to the trackframe such that when the vehicle is on a horizontal flat surface, a segment of the track vertically below a bottommost point of the sprocket wheel is free from contact with the surface.

There is also disclosed a tree stump extraction tool to be mounted on a vehicle having activation means for activating the tool, the tool comprising an upper end and a lower end, pivoting means defining a pivot axis at the upper end for pivotally mounting the tool to the vehicle, and a set of substantially parallel teeth solidly coupled to the lower end, each tooth comprising a pointed end extending generally forwardly from the bottom end. When the tool is activated by the activation means to pivot the tool in an upward or downward motion, the teeth are respectively rotated upwardly or downwardly about the axis.

Additionally, there is also disclosed a method for extracting a tree stump from the ground comprising the steps of:
a) providing a tool pivotally mounted on, and activated by, a vehicle having activation means for activating the tool, the tool comprising an upper end and a lower end, pivoting means defining a pivot axis at the upper end for pivotally mounting the tool to the vehicle, and a set of substantially parallel teeth solidly coupled to the lower end, each tooth comprising a pointed end extending generally forwardly from the bottom end;
b) targeting the tree stump to be extracted;
c) moving the vehicle toward the stump such that the teeth engage a bottom section of the stump; and
d) activating the activation means for pivoting the tool, upwardly rotating the teeth about the axis, and consequently at least partially extracting the stump from the ground.

Other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

Having thus generally described the nature of the invention, reference will now be made to the accompanying drawings, showing by way of illustration an illustrative embodiment thereof, and in which:

FIG. 1 is a front perspective view of a land clearing vehicle in accordance with an illustrative embodiment of the present invention;

FIG. 2 is another front perspective view of the land clearing vehicle of FIG. 1;

FIGS. 3a and 3b schematically illustrate the sequential operation of a tree stump extraction tool, of the land clearing vehicle of FIG. 1, also in accordance with an illustrative embodiment of the present invention;

FIGS. 4a and 4b are respectively exploded and assembled perspective views of a track assembly (without the track), of the land clearing vehicle of FIG. 1, also in accordance with an illustrative embodiment of the present invention;

FIG. 5 is a rear perspective view, partly exploded, of the track assembly of FIG. 4b being fitted to the land clearing vehicle in accordance with an illustrative embodiment of the present invention;

FIG. 6 is a bottom perspective view of a land clearing vehicle without one of its track assemblies to better illustrate the bottom of the land clearing vehicle, in accordance with an illustrative embodiment of the present invention;

FIGS. 7a and 7b are side views of the track assembly, with a rear sprocket wheel thereof shown respectively in lowered and raised positions thereof, in accordance with an illustrative embodiment of the present invention; and

FIG. 7c is an enlarged view of the circled area in FIG. 7b, showing the rear sprocket wheel of the track assembly, in its raised position.

### DESCRIPTION OF THE ILLUSTRATIVE EMBODIMENTS

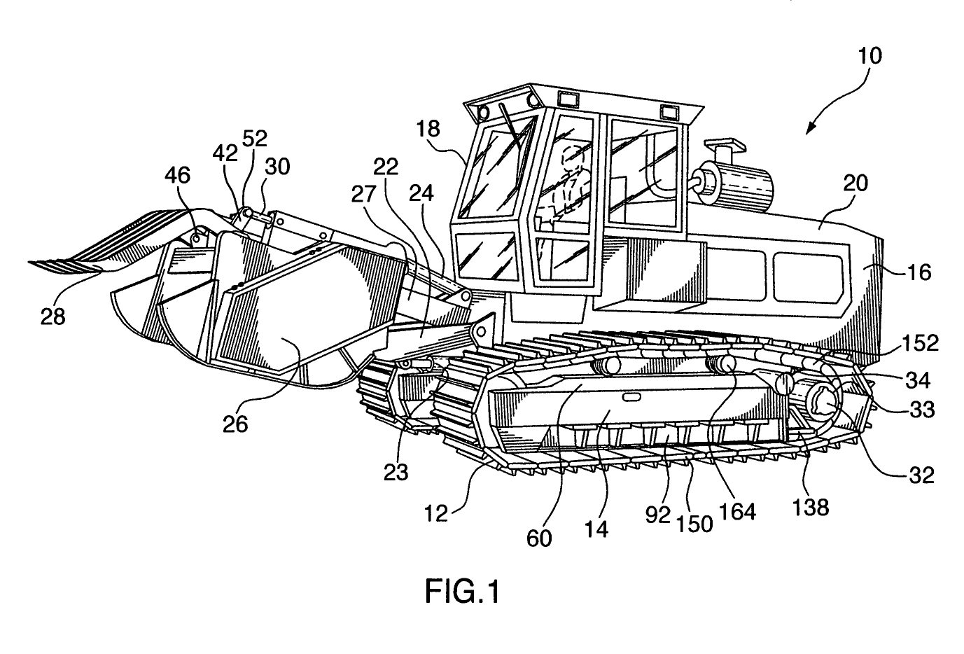

Referring now to FIG. 1, a land clearing vehicle, generally referred to using the numeral 10, and in accordance with an illustrative embodiment of the present invention, will now be described. The land clearing vehicle 10 is generally a heavy-duty vehicle configured for traveling and maneuvering in rough terrain conditions. The vehicle generally comprises a set of tracks 12, mounted around trackframes 14, securely linking the tracks to a main body 16 of the vehicle. The main body 16 generally comprises a cabin 18, from which an operator may bring the vehicle to complete various tasks through various controls (not shown), and a ventilated casing 20 for housing, amongst other things, the vehicle's engine, cooling system, electronics, hydraulic system, and other components of the sort. At the front of the vehicle, a lifting arm 22, generally hydraulically activated by respective hydraulic lift 23 and tilt 24 cylinders, allows for the installation and manipulation of various tools to be used in conjunction with the land clearing vehicle. In this particular illustrative embodiment, the vehicle is fitted with a heavy-duty mulching machine 26 at the end of lifting arm 22, activated by a protected drive shaft (hidden by protective drive shaft guard 27), and a tree stump removal tool 28, which is hydraulically activated by a set of hydraulic cylinders 30 fastened atop the mulching machine 26.

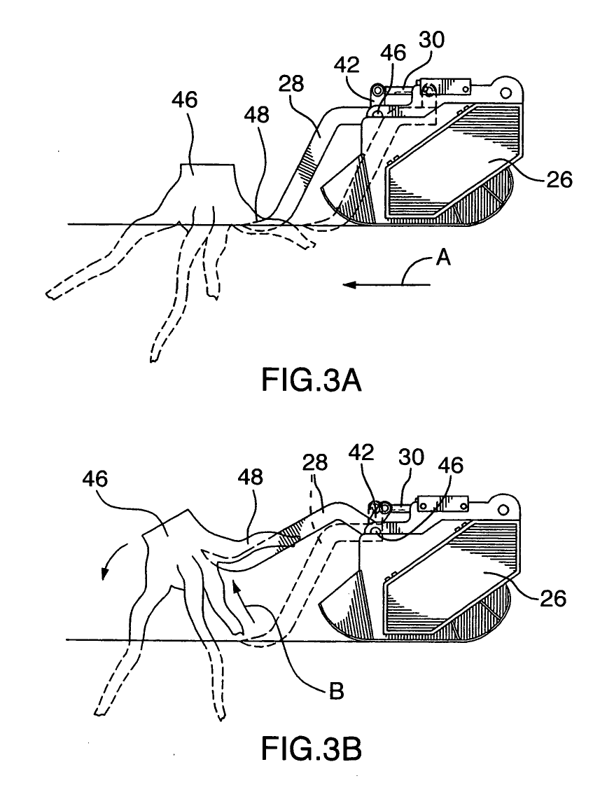

As it will become apparent to a person skilled in the art, a land clearing vehicle, such as the one illustrated at 10 in FIG. 1, will be powered accordingly for the task to be completed. In this particular illustrative embodiment, the vehicle 10 comprises a hydrostatic drive system powered by a heavy-duty diesel engine, such as a Cummins™ 550 horsepower diesel engine. The engine drives two closed-circuit variable flow pumps hydraulically coupled to two hydraulic piston motors (reference 126 of FIG. 3), such as the Series 90 100 CC pumps and two-speed motors by Sundstrand™. The two pumps and motors, controlled by electronic joystick-type controls, independently drive a set of sun gear assemblies 32, each protected by a driven outer shell 33, which are ultimately coupled to the tracks 12 by a set of sprocket wheels 34 securely fastened thereon. Within each sun gear assembly 32, a parking/emergency brake is provided and applied to the motors when the diesel engine is not in operation.

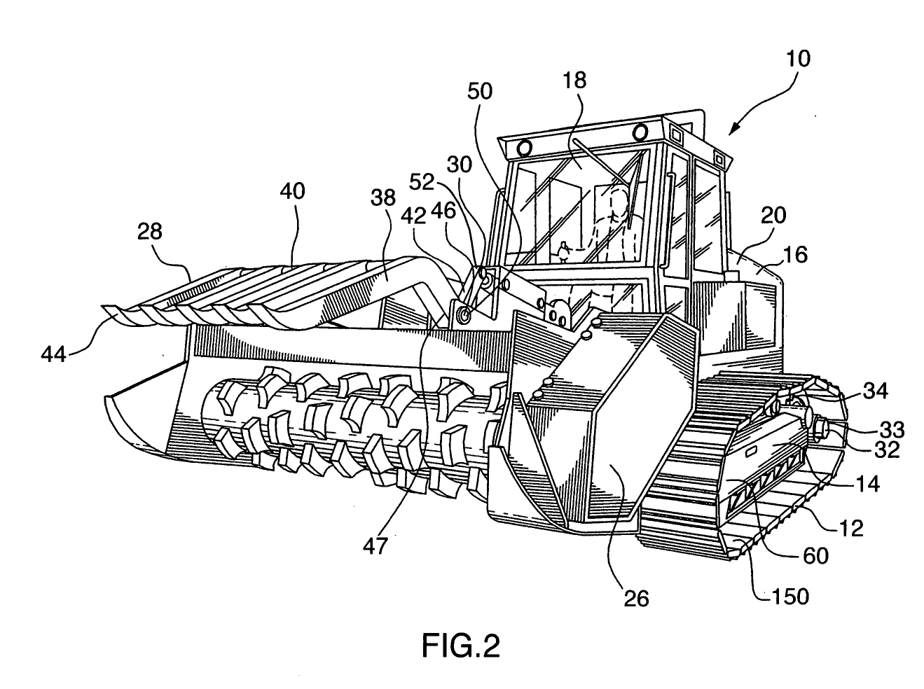

Referring now to FIG. 2 in conjunction with FIG. 1, and in accordance with an illustrative embodiment of the present invention, the land clearing vehicle 10 is again fitted with both a mulching machine 26 and a tree stump removal tool 28 pivotally mounted at the front thereof. The stump removal tool 28 is comprised of a generally vertical comb-like structure 38, manufactured of a considerably strong and resilient material such as steel or other industrial strength materials of the like, integrally coupled at a rear end thereof to a base 40 substantially perpendicularly oriented thereto. The base 40 then links the comb-like structure 38 to two (2) hydraulically activated L-shaped arms 42 which provide mounting and pivoting means to the stump removal tool 28. At a bottom free end of the tool 28, the comb-like structure 38 terminates in a set of pointed teeth 44, usually between four (4) and six (6), generally extending roundly forwardly from the structure 38. Additional transversal supports, possibly in the form of horizontal stabilizer rods or bars, may be added along the length of the comb 38 to reinforce the structure 38.

Still referring to FIGS. 1 and 2, the stump removal tool 28 is pivotally and solidly mounted to the mulching machine 26 using a set of cylindrical bushings 46 fitted through the respective vertices 47 of the L-shaped arms 42, defining a pivot axis 50. The set of hydraulic cylinders 30, are coupled to upper ends 52 of the L-Shaped arms 42, and thus above axis 50, providing leverage for the stump removal tool 28 about the pivot axis 50, which essentially acts as a fulcrum for the rotation of the tool 28. Necessarily, when the hydraulic cylinders 30 apply a pulling force on the L-shaped arms 42, the tool 18 is rotated upwardly about axis 50 and the teeth 44 are brought up from the ground. Clearly, a person of skill in the art will understand that the tool 28 could also be set up to be activated by a set of hydraulics connected below the pivot axis, in which case a pushing force would need to be applied to the tool 28 in order to raise the teeth 44. Furthermore, although the pivoting means are illustrated in this embodiment as being hydraulic in nature, other pivoting means, such as mechanical or pneumatic means, could also be used to activate the tool 28.

Now referring mainly to FIG. 3, but in conjunction with FIGS. 1 and 2, and in accordance with an illustrative embodiment of the present invention, the operation of the tree stump removal tool 28 will now be presented. In FIG. 3a, the tree stump removal tool 28, presented here as pivotally mounted to the mulching machine 26, is shown to move forward along arrow A toward a tree stump 46. As the teeth 44 of the tool 28 are moved forward, they engage a bottom portion 48 of the tree stump 46. In FIG. 3b, the hydraulic cylinders 30 are activated such that the teeth 40 are rotated upwardly along arrow B, partially extracting the stump 46 from the ground. In order to fully extract the stump 46 from the ground, the tool 28 may be further moved toward the stump 46, maintaining engagement therewith, and further rotated upwardly until the stump 46 is fully extracted. Once fully extracted, the stump 46 is either removed from the site using appropriate machinery, or again mulched using, for example, a mulching machine such as the one illustrated in FIGS. 1, 2 and 3.

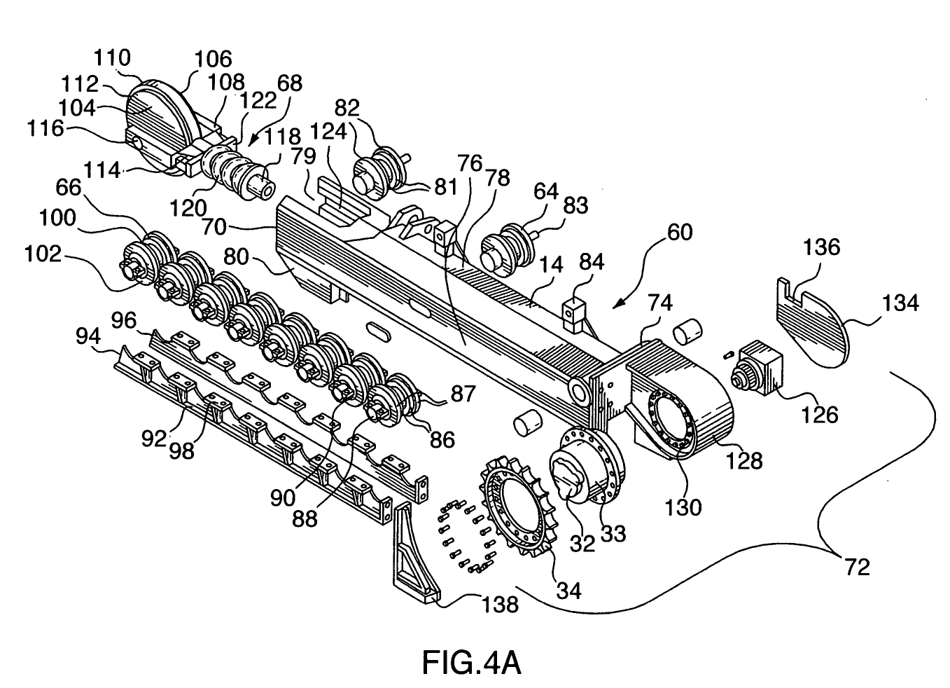

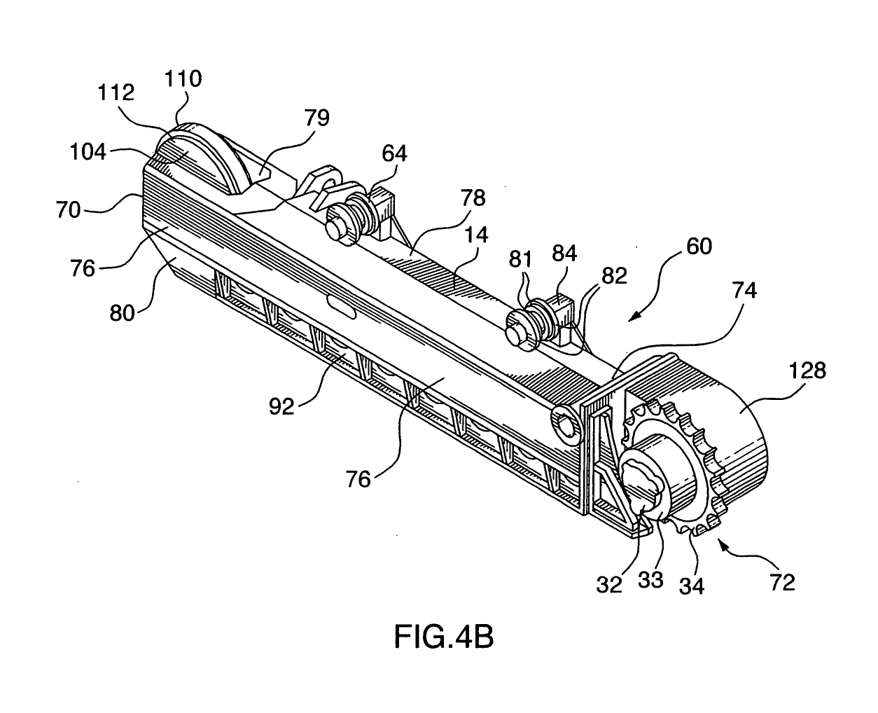

Referring now to FIGS. 4a and 4b, a track assembly for a land clearing vehicle such as vehicle 10, generally referred to using the numeral 60, and in accordance with an illustrative embodiment of the present invention, will now be described. The track assembly 60 generally comprises trackframe 14, a set of upper rollers 64 and bottom rollers 66 rotatably coupled thereto, a tensioner assembly 68 retractably coupled at the front end 70 of the trackframe 14 and a track driving system 72 located at the rear end 74 of same. The trackframe 14, which is essentially used to hold and house the majority of track assembly components, generally consists of a hollow elongated rectangular box having side and top panels 76 and 78 respectively, the latter of which comprising an open-ended rectangular cutout 79 at the front thereof for accepting part of the tensioner assembly 68 therein (discussed further hereinbelow). An additional set of guards 80 is also securely fitted to the bottom of the side panels 76 at the front end 70 of the trackframe 14.

The two upper rollers 64, each generally comprising a set of double rollers 81 having exterior track guiding edges 82 and rotating freely about a same axle 83, are rotatably coupled to the trackframe 14 by coupling the roller axles 83 to respective roller supports 84 integrally fitted to the top panel 78 of the trackframe 14. The bottom rollers 66, also generally comprising double rollers 86 having exterior track guiding edges 87 and rotating freely about a same axle 88, are rotatably coupled to the trackframe side panels 76 by a set of axle supports 90 securely fastened to the bottom of same using a set of bolts or other fastening means of the like. In this illustrated embodiment, the vehicle 10 is comprised of eight (8) bottom rollers 66, though an alternative illustrative embodiment could comprise more than eight (8) bottom rollers, such as eleven (11) bottom rollers 66. Due to the high number of bottom rollers 66, the weight of the vehicle 10 is better distributed on the bottom track. Furthermore, the high number of bottom rollers 66 improves the vehicle's ability to manoeuvre in rough terrain conditions, providing greater support, and thus increased durability for the track 12.

Additionally, still referring to FIGS. 4a and 4b and in accordance with an illustrative embodiment of the present invention, a set of roller guards 92 are fastened to the bottom of the trackframe side panels 76 adjacent guard 80 in order to protect the bottom rollers 66 in rough terrain conditions. In this specific embodiment, a roller guard 92 is generally comprised of a flat elongated structure 94 having a series of arcuate cutouts 96 at the top thereof for accepting the generally circular roller axle supports 90 therein. The cutouts 96 are interspersed between a set of fastening flanges 98 used to securely fasten the roller guard 92 to the bottom of the trackframe side panels 76 using a set of bolts or other fastening means of the like; the cutouts 96 coincide with the axle supports 90 allowing the flanges 98 to be fastened therebetween. Consequently, the top portion 100 of the bottom rollers 66 is efficiently protected by the trackframe side panels 76, whereas the bottom portion 102 of the bottom rollers 66 is efficiently protected by the roller guards 92, significantly reducing the possibility of interference or obstruction from debris, branches, vegetation or other items of the like scattered around the work area. By providing the bottom rollers 66 with such fitted roller guards 92, the efficiency and lifespan of the track assembly 60 is significantly increased.

Still referring to FIGS. 4a and 4b, and in accordance with an illustrative embodiment of the present invention, the tensioner assembly 68 is generally comprised of a tensioner wheel 104 rotatably installed at the distal end 106 of a spring-loaded tensioner arm 108, itself retractably coupled to the front end 70 of the trackframe 14. The tensioner wheel 104 generally consists of an elevated central disc 110 and two (2) lateral discs 112, for coupling with the inner surface of the track 12 (discussed further hereinbelow). A bifurcated wheel coupler 114 rotatably links an axle 116 of the tensioner wheel 104 to the tensioner arm 108. A shaft 118 of the tensioner arm 108 is moveably fitted with a heavy-duty spring 120, which abuts against the proximal end 122 of the wheel coupler 114. The tensioner assembly 108 is then inserted into the front end 70 of the trackframe 14, guided by a set of lateral runners 124 designed to slidably accept the lateral edges of the bifurcated coupler 114 and a shaft guide (not seen) designed to both slidably accept the tensioner shaft 118 and provide a fixed surface upon which the spring 120 may be compressed during tensioner retraction. In its resting position, the tensioner assembly 68 is positioned such that the tensioner wheel 104 may rotate freely within the trackframe top panel opening 79, which allows the tensioner wheel 104 to be partially hidden and protected by the trackframe side panels 76 and guards 80.

Accordingly, and in accordance with an illustrative embodiment of the present invention, the tensioner assembly 68 will provide means for maintaining a substantially constant tension in the track. Consequently, the track 12, and the vehicle 10 it is mounted on, will be provided with better means for addressing and maneuvering in precarious terrain conditions. Furthermore, if an object, such as debris, branches, vegetation, or other items of the like, interferes with, or becomes lodged between, the track 12, the rollers 64, 66, the sprocket wheel 34, the trackframe 14 or any other component of the track assembly 60, the tensioner assembly 68 will automatically retract within the trackframe 14 and release the track 12, thereby reducing the risk of damage to the track 12 and other components of the track assembly 60. As it will now be apparent to a person of skill in the art, other such tensioner assemblies may be developed without departing from the general scope of the illustrated embodiment. For instance, a tensioner assembly generally comprising a tensioner arm and wheel fitted with a hydraulic, pneumatic, or even magnetic restoring system could just as well replace the illustrated spring-loaded mechanism and provide similar advantages.

Still referring to FIGS. 4a and 4b, and in accordance with an illustrative embodiment of the present invention, the track driving system 72 generally comprises a hydraulic motor 126 coupled to a sun gear assembly 32 protected by a driven shell 33, and a sprocket wheel 34 solidly fastened thereon. In order to properly protect the components of the track driving system 72, the motor 126 is securely mounted within a protective casing 128 solidly fastened to the rear end 74 of the trackframe 14. From this protective casing 128, the motor 126 engages the sun gear assembly 32 that drives the protective shell 33 rotatably mounted to the casing 128 through bearings 130, which itself drives the sprocket wheel 34 solidly mounted thereon. A protective casing plate 134 provides protection to motor 126 from the inside of the trackframe 14, while still providing an opening 136 for passing driving hydraulic lines (not seen) from the main body 16 to the motor 126. A protective skate 138 is fastened to the back end 74 of trackframe 14, providing added protection to the sprocket wheel 34 and sun gear assembly 32. Unlike conventional vehicles, the track assembly 60 of the present illustrative embodiment offers the protected track driving system 72 directly within the trackframe 14. Consequently, the track driving system 72 is very well protected by the trackframe 14 and track 12 from interference or obstructions from outside elements such as branches, debris, vegetation, and other items of the like, thereby increasing the lifespan of its components.

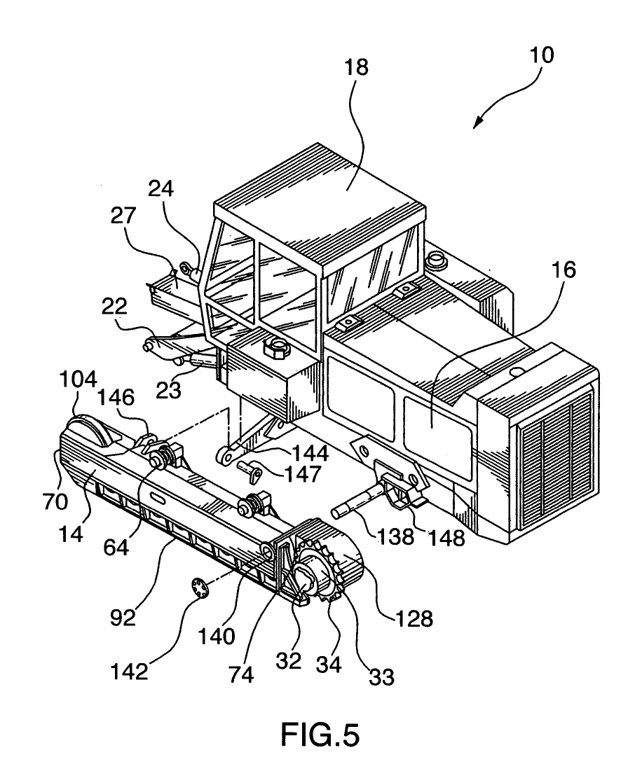

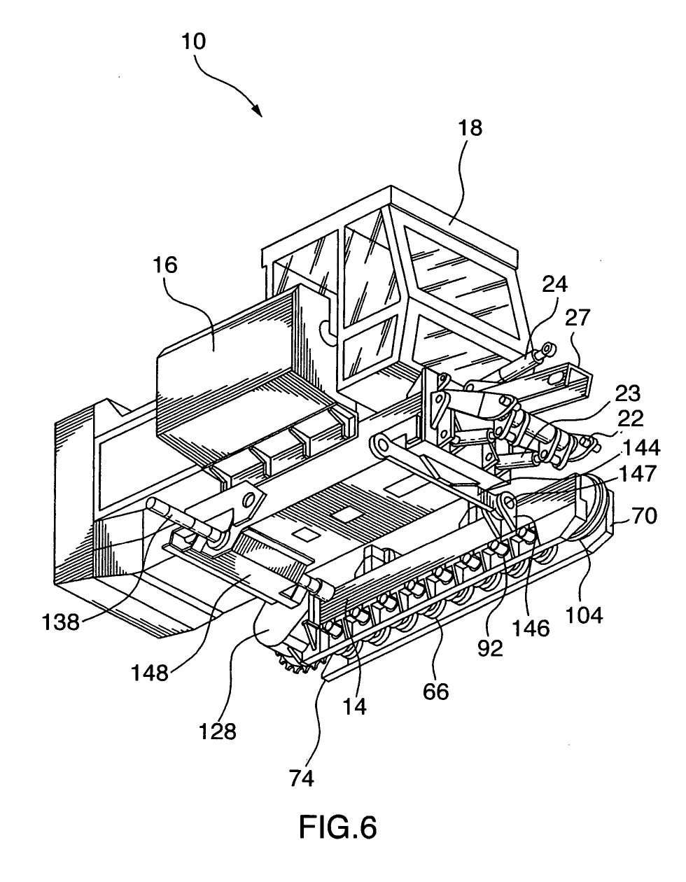

Now referring to FIGS. 5 and 6 in conjunction with FIGS. 4a and 4b, and in accordance with an illustrative embodiment of the present invention, the track assembly 60 is securely installed to the main body 16 of the land clearing vehicle 10. A rear suspension shaft 138 is fitted to a cylindrical suspension shaft housing 140 at the rear end 74 of the trackframe 14 and capped with a cap 142, whereas a front suspension arm 144 is secured to a suspension joint 146 at the front end 70 of the trackframe 14, with a pin 147. In order to provide full protection to the vehicle driving means, a pan 148, fastened to the bottom of the land clearing vehicle 10, is fitted such that hydraulic lines (not shown) provided from the hydraulic pumps (also not shown) within the main body 16 to drive the hydraulic motors 126 secured within the protective casing 128, will be guided thereto under full protection by the pan 148.

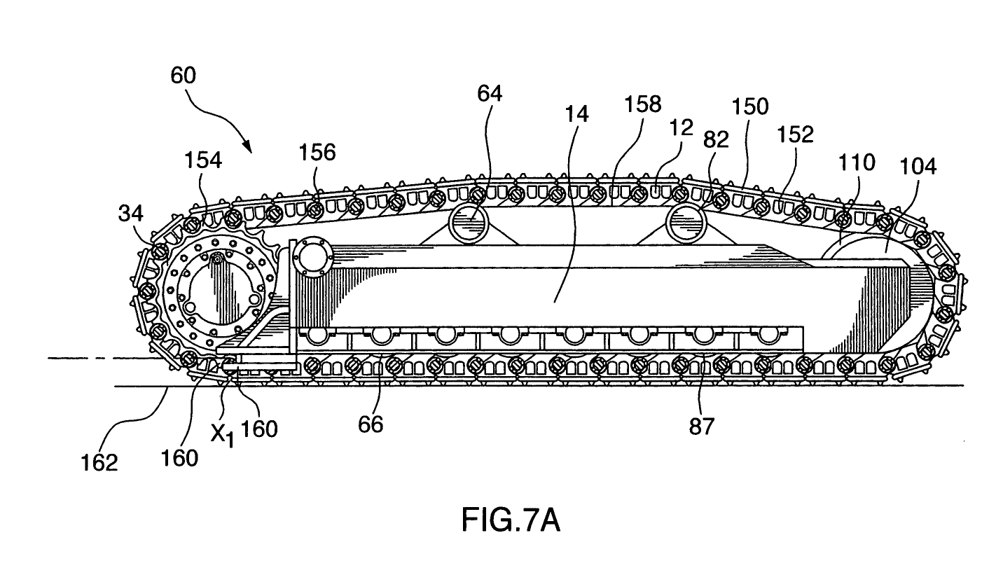

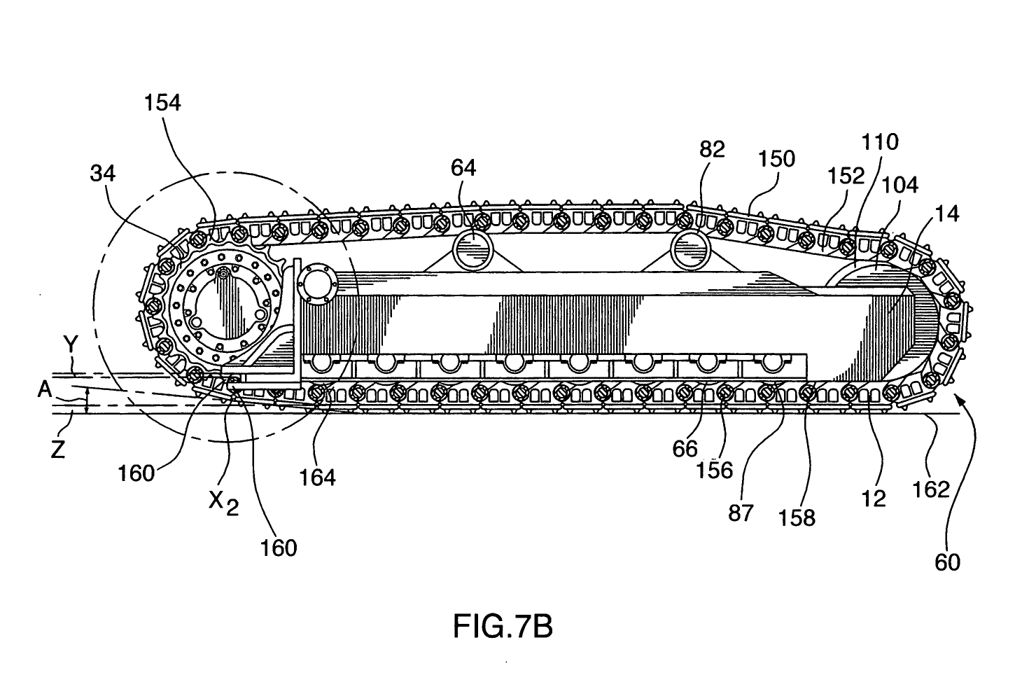

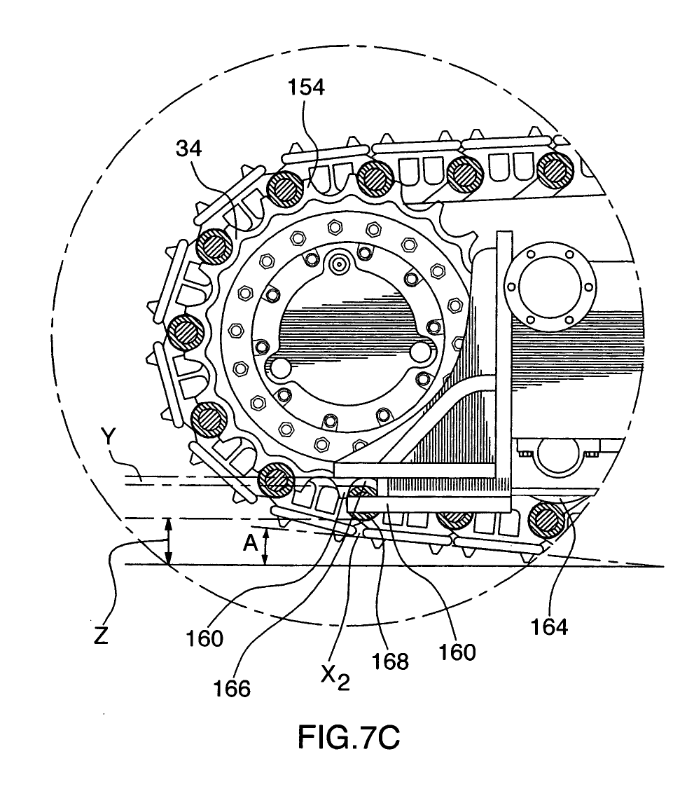

With reference to FIGS. 4a, 4b and 7, and in accordance with an illustrative embodiment of the present invention, the track 12 is mounted on the track assembly 60, such that it may be guided by the bottom rollers 66, the tensioner wheel 104 and the top rollers 64, and driven by the sprocket wheel 34. Essentially, the track 12 consists of a set of substantially flat and likely ribbed panels 150, on which is mounted a drive chain 152. The teeth 154 of the sprocket wheel 34 drive the track 12 by coupling themselves around hinges 156 of the drive chain 152. The driven track is then guided around the trackframe 14 as outside faces 158 of the drive chain 152 are guided by the respective outside edges 82 and 87 of the top and bottom rollers 64 and 66, and the central disc 110 of the tensioner wheel 104.

In FIG. 7a, the sprocket wheel 34 is level with the rollers. In other words, at point X₁ where the drive chain 152 is first grabbed between the two bottommost teeth 160 of the sprocket wheel 34 (or first released when the vehicle 10 is in reverse mode), the track 12 is still in contact with the ground 162. Consequently, the weight of the vehicle is distributed both on the bottom rollers 66 and the sprocket wheel 34, as pressure between the ground and the track 12 at point X₁ is directly transmitted to the sprocket wheel 34.

Alternatively in FIG. 7b, the sprocket wheel 34 is raised upwardly, if only by a fraction of an inch, such that at point X₂ where the drive chain 152 is first grabbed between the two (2) bottommost teeth 160, the track is not in contact with the ground. In this alternative embodiment, the sprocket wheel 34 does not directly bear any of the vehicle's weight as there is no direct pressure transfer from the ground 162 to the sprocket wheel 34. As a result of the sprocket wheel configuration of FIG. 7b, the sprocket wheel lifespan is drastically increased, reportedly up to four times the lifespan of a sprocket wheel configured as in FIG. 7a.

Accordingly, two particular features help distinguish the configuration of FIG. 7b from the configuration of FIG. 7a to determine whether any of the vehicle's weight is being applied to the sprocket wheel 34. Firstly, the track 12 of FIG. 7b, better seen in FIG. 7c, makes an angle A with the ground 162 between the last roller 164 and the sprocket wheel 34. Though this angle A may be small, it suffices to bring the track 12 away from the ground at the first point of contact X₂ with the sprocket wheel 34. In the illustrated embodiment, the vertical distance Z between the track 12 and the ground 162 at the point X₂ is generally between one quarter (¼) inch and three (3) inches. In an alternative illustrative embodiment of the present invention, the distance Z is between one quarter (¼) inch and one (1) inch. In a further alternative illustrative embodiment of the present invention, the distance Z is about three quarter (¾) inches.

Secondly, if one observes the bottommost hinge-receiving surface 166 of the sprocket wheel 34, that is the rounded track-bearing surface between the two (2) bottommost teeth 160, one observes in FIGS. 7b and 7c that the critical hinge 168 is not fully inserted between the teeth 160, observing a distance Y therebetween, indicating that no direct pressure from the ground is applied at that point. These two characteristics, observed independently or simultaneously, imply that no direct pressure is applied to the sprocket wheel 34 from the ground 162, and that the sprocket wheel will benefit from an increased lifespan.

As described hereinabove with reference to the cited Figures, the track assembly 60 of the illustrated embodiments presents various protective measures for insuring an optimal durability of the track assembly components. Namely, the track assembly 60 provides a fully protected track driving system, a set of roller guards 92 for protecting the bottom rollers 66, a tensioner assembly 68 that provides added protection to the track 12 and other track assembly components, and a driving sprocket wheel 34, elevated to significantly increase its lifespan. Furthermore, a novel tree stump removal tool 28 is provided to increase the productivity and efficiency of the land clearing vehicle 10.

While this invention has been described with reference to the illustrative embodiments, this description is not intended to be construed to a limiting sense. Various modifications or combinations of the illustrative embodiments, as well as other embodiments of the invention, will be apparent to persons skilled in the art upon reference to the description. It is therefore intended that the described invention encompass any such modifications or embodiments.

We claim:

1. A track assembly for a tracked vehicle, the track assembly comprising an elongated trackframe comprising an inner panel and an outer panel, a set of bottom rollers rotatably mounted between a bottom inner edge of said inner panel and a bottom outer edge of said outer panel, and at least one roller guard mounted on said trackframe, said roller guard extending substantially downwardly from said trackframe to at least partially protect said rollers.

2. A track assembly as claimed in 1 wherein said rollers comprise an outer side and an inner side, said roller guard extending generally downwardly from said trackframe to at least partially protect at least one of said outer side and said inner side.

3. A track assembly as claimed in 2 wherein each said roller comprises at least one roller wheel mounted to a roller axle, each said roller axle being rotatably mounted to said bottom inner edge and said bottom outer edge using axle supports.

4. A track assembly as claimed in 3 wherein said roller guard comprises an elongated structure, said elongated structure comprising a set of cutouts and a set of mounting flanges for mounting said roller guard to said bottom edge of said inner panel or said bottom edge of said outer panel; wherein said flanges are mounted between said axle supports and said cutouts contour same.

5. A track assembly as claimed in 4 wherein said roller wheels are substantially hidden and protected by said inner panel, said outer panel and said roller guard.

6. A track assembly for a tracked vehicle, the track assembly comprising an elongated trackframe and a hollow protective casing at a first end thereof, a track, a track driving means comprising a motor, a drive train and a drivable sprocket wheel drivingly coupled thereto for driving said track, wherein said motor and said drive train are mounted in, and protected by, said protective casing.

7. A track assembly as claimed in 6 wherein said motor is a hydraulic motor.

8. A track assembly as claimed in 7 wherein said hydraulic motor is activated by a set of hydraulic lines connected and provided thereto through an opening defined in said protective casing.

9. A track assembly as claimed in 8 wherein a protective pan is provided underneath the vehicle for protectively guiding said hydraulic lines to said protective casing and said motor.

10. A track assembly as claimed in 6 wherein said drive train comprises a sun gear assembly driven by said motor, said sun gear assembly comprising a driven outer protective shell.

11. A track assembly as claimed in 10 wherein said sprocket wheel is mounted on, and directly driven by, said outer protective shell.

12. A track assembly as claimed in 11 wherein said outer protective shell is rotatably mounted to said protective casing hiding said motor therein.

13. A track assembly as claimed in 12 wherein said motor and said sun gear assembly are substantially completely encased and protected from interfering objects by said protective casing and said protective shell.

14. A track assembly as claimed in 13 wherein a protective pan is provided underneath the vehicle for protectively guiding said hydraulic lines to said protective casing and said motor.

15. A track assembly as claimed in 14 wherein said motor, said drive train and said hydraulic lines are substantially completely encased, and protected from interfering objects by said protective pan and said protective casing.

16. A track assembly as claimed in 6, wherein said trackframe comprises an inner panel and an outer panel, the track assembly further comprising a set of bottom rollers rotatably mounted between a bottom inner edge of said inner panel and a bottom outer edge of said outer panel and at least one roller guard mounted to said trackframe, said roller guard extending substantially downwardly from said trackframe to at least partially protect said rollers.

17. A track assembly for a tracked vehicle, the track assembly comprising a trackframe and a set of rollers rotatably attached thereto, an automatic tensioner assembly comprising a restoring arm retractably coupled to said trackframe and extending outwardly therefrom to a tensioner wheel rotatably fastened thereto at a distal end thereof, and a track comprising an inner track surface movably mounted on said rollers and said tensioner wheel.

18. A track assembly as claimed in 17 wherein said tensioner assembly maintains a substantially constant tension in said track through said restoring arm.

19. A track assembly as claimed in 18 wherein when a foreign object interferes with said track assembly such that a pre-determined track tension may not be maintained by said tensioner assembly, said tensioner assembly fully retracts within said trackframe and automatically releases said track.

20. A track assembly as claimed in 17 wherein a restoring force of said restoring arm is at least one of hydraulic, pneumatic, magnetic and elastic.

21. A track assembly as claimed in 17 wherein said restoring arm is spring-loaded.

22. A track assembly as claimed in 17 wherein said trackframe is generally horizontally elongated and said tensioner assembly is retractably coupled to said trackframe at a first distal end thereof.

23. A track assembly as claimed in 22 wherein said tensioner wheel is rotatably fastened to said restoring arm through a bifurcated wheel support.

24. A track assembly as claimed in 23 wherein said wheel and said wheel support are partially inserted inside said trackframe.

25. A track assembly as claimed in 24 wherein said wheel support is slidably guided within said trackframe by lateral runners.

26. A track assembly as claimed in 22 further comprising a track driving means.

27. A track assembly as claimed in 26 wherein said track driving means comprises a drivable sprocket wheel drivingly coupled to said track inner surface for driving said track, said sprocket wheel being rotatably mounted at a second distal end of said trackframe.

28. A track assembly as claimed in 27 wherein said tensioner assembly is adapted to maintain a substantially constant tension in said track through said restoring arm.

29. A track assembly as claimed in 28 wherein when a foreign object interferes with said track assembly such that a pre-determined track tension may not be maintained by said tensioner assembly, said tensioner assembly fully retracts within said trackframe and automatically releases said track.

30. A track assembly as claimed in 27 wherein said sprocket wheel is mounted to said trackframe such that when the vehicle is on a horizontal flat surface, a segment of said track vertically below a bottommost point of said sprocket wheel is free from contact with said surface.

31. A track assembly as claimed in 27 wherein said trackframe comprises a hollow protective casing at said second distal end, and wherein said driving means comprises a motor and a drive train securely fastened within said protective casing and drivingly coupled to said sprocket wheel for driving said track.

32. A track assembly as claimed in 17 further comprising at least one roller guard fastened to said trackframe, wherein said roller guard extends generally vertically downwardly form said trackframe to at least partially protect at least one roller.

33. A track assembly for a tracked vehicle, the track assembly comprising a substantially horizontal elongated trackframe and a set of rollers rotatably fastened thereto, a track comprising an inner track surface, a track driving means comprising a drivable sprocket wheel for driving said track, said sprocket wheel being rotatably mounted at a first distal end of said trackframe; wherein said track inner surface is moveably mounted on said rollers and drivingly coupled to said sprocket wheel and wherein said sprocket wheel is mounted to said trackframe such that when the vehicle is on a horizontal flat surface, a segment of said track vertically below a bottommost point of said sprocket wheel is free from contact with said surface.

34. A track assembly as claimed in 33 wherein a vertical distance between said segment vertically below said bottommost point of said sprocket wheel and a segment of said track vertically below a bottommost point of a roller adjacent to said sprocket wheel is between one quarter inch and three inches.

35. A track assembly as claimed in 34 wherein said vertical distance is between one quarter inch and one inch.

36. A track assembly as claimed in 33 wherein said sprocket wheel comprises a set of sprockets for driving said track and a set of sprocket wheel track-bearing surfaces therebetween; and wherein a bottommost track-bearing surface is free of contact with said track.

37. A track assembly as claimed in 33 wherein said vehicle is a land clearing vehicle.

38. A track assembly as claimed in 33 wherein the vehicle has a weight, said set of rollers substantially bearing all of said weight with said sprocket wheel substantially bearing none of said weight.

39. A track assembly as claimed in 33 wherein said rollers are at least partially protected by at least one roller guard fastened to said trackframe.

40. A track assembly as claimed in 33 wherein said trackframe comprises a hollow protective casing at said first distal end thereof, and wherein said driving means further comprise a motor and a drive train securely fastened within said protective casing and drivingly coupled to said sprocket wheel for driving said track.

41. A land clearing tool to be mounted on a land clearing vehicle having activation means for activating the tool, the tool comprising:
an upper end and a lower end;
pivoting means defining a pivot axis at said upper end for pivotally mounting the tool to the vehicle; and
a set of substantially parallel teeth solidly coupled to said lower end, each said teeth comprising a pointed end extending generally forwardly from said bottom end;
wherein when the tool is activated by the activation means to pivot the tool in an upward or downward motion, said teeth are respectively rotated upwardly or downwardly about said axis.

42. A tool as claimed in 40 wherein the activation means are at least one of hydraulic, pneumatic and mechanical.

43. A tool as claimed in 40 wherein the tool is used to at least partially extract a tree stump from the ground.

44. A tool as claimed in 42 wherein the tool is mounted to, and extends generally forwardly from, a mulching machine on the vehicle.

45. A tool as claimed in 40 wherein the activation means comprise an activation arm linking the vehicle to said upper end of the tool at an activation point above said pivot axis such that applying a pulling force on said activation arm induces an upward rotation of said tool.

46. A tool as claimed in 40 wherein the activation means comprise an activation arm linking the vehicle to said lower end of the tool at an activation point below said pivot axis such that applying a pushing force on said activation arm induces a upward rotation of said tool.

47. A method for extracting a tree stump from the ground comprising the steps of:
a) providing a tool pivotally mounted on, and activated by, a vehicle having activation means for activating said tool, said tool comprising an upper end and a lower end, pivoting means defining a pivot axis at said upper end for pivotally mounting said tool to said vehicle, and a set of substantially parallel teeth solidly coupled to said lower end, each said teeth comprising a pointed end extending generally forwardly from said bottom end;
b) targeting the tree stump to be extracted;
c) moving said vehicle toward the stump such that said teeth engage a bottom section of the stump;
d) activating said activation means for pivoting said tool, upwardly rotating said teeth about said axis, and consequently at least partially extracting the stump from the ground.

48. A method as claimed in 47 further comprising the additional steps of:
e) moving said vehicle toward the stump while maintaining engagement between said teeth and said bottom section of the stump;
f) activating said activation means for pivoting said tool, further upwardly rotating said teeth about said axis, and consequently further extracting the stump from the ground;
g) repeating steps e) and f) until the stump is fully extracted.

49. A method as claimed in 47 wherein said tool is mounted to, and extends generally forwardly from, a mulching machine on said vehicle.

50. A method as claimed in 49 further comprising the additional steps of:
e) establishing if the stump has been sufficiently extracted for mulching by said mulching machine;
f) if the stump is not sufficiently extracted for mulching:
(i) moving said vehicle toward the stump while maintaining engagement between said teeth and said bottom section of the stump;
(ii) activating said activation means for pivoting said tool, further upwardly rotating said teeth about said axis, and consequently further extracting the stump from the ground;
(iii) repeating steps (i) to (iii) as necessary to sufficiently extract the stump for mulching;
g) when the stump is sufficiently extracted for mulching:
(i) moving said vehicle away from the stump;
(ii) activating said activation means for pivoting said tool upwardly to provide said mulching machine with access clearance to the stump; and
(iii) moving said vehicle toward the stump for mulching.

51. A method as claimed in 47 wherein the activation means comprise an activation arm linking the vehicle to said upper end of the tool at an activation point above said pivot axis such that applying a pulling force on said activation arm induces an upward rotation of said tool about said axis.

52. A method as claimed in 47 wherein the activation means comprise an activation arm linking the vehicle to said lower end of the tool at an activation point below said pivot axis such that applying a pushing force on said activation arm induces a upward rotation of said tool about said axis.

53. A method as claimed in 47 wherein the activation means are at least one of hydraulic, pneumatic and mechanical.
